(19) United States
(12) Patent Application Publication
(10) Pub. No.: US 2012/0301242 A1
(43) Pub. Date: Nov. 29, 2012

(54) METHOD OF MANUFACTURING WORKPIECE

(75) Inventor: Yoshihiro Uehara, Kawasaki-shi (JP)

(73) Assignee: CANON KABUSHIKI KAISHA, Tokyo (JP)

(21) Appl. No.: 13/468,153

(22) Filed: May 10, 2012

(30) Foreign Application Priority Data
May 24, 2011 (JP) 2011-115388

(51) Int. Cl. B23Q 11/00

(52) U.S. Cl. 409/131

(57) ABSTRACT

Provided is a method of manufacturing a workpiece, which is capable of processing a workpiece in one processing with high precision. The method of manufacturing includes: changing a relative orientation of a unit removal shape and the workpiece; setting relative positions of a rotation shaft of a rotating polishing tool and the workpiece so as to have a relative orientation having a smallest difference among differences between a calculated removal shape and a target removal shape determined for each of the relative orientations; and processing the workpiece at a relative speed in accordance with a dwell-time distribution. The method of manufacturing is capable of processing the workpiece with little error in one scanning for processing, and hence it is possible to increase precision of a workpiece surface and improve processing efficiency by reducing the number of repetition of the processing.

### BACKGROUND OF THE INVENTION

1. Field of the Invention

The present invention relates to a method of manufacturing a workpiece, for processing a workpiece typified by an optical element such as a lens or a mirror, a metal such as a die, and a semiconductor element substrate such as a silicon wafer with high precision.

2. Description of the Related Art

There are cases where a workpiece typified by an optical element such as a lens or a mirror, a metal such as a die, and a semiconductor element substrate such as a silicon wafer requires high-precision processing.

In the steps of the processing, the formation of the entire workpiece surface of the workpiece and the removal of an undulation called a ripple at a period of about 1 mm to 10 mm and roughness in a frequency region equal to or lower than the period are performed. Such polishing is not completed in one polishing process, but is performed by repeating multiple processes that use different movements of a tool, different types of tools, and different polishing liquids. In particular, the optical element as a large workpiece to be mounted in an aligner is often processed by using a tool having an area to be brought into contact with the optical element smaller than an area of a portion to be processed. For example, there is known a processing method in which, while a tire-shaped tool that rotates about a shaft substantially in parallel with a workpiece surface is pressed against the workpiece surface, the tire-shaped tool and the workpiece are moved relative to each other, to thereby process the workpiece surface (hereinafter, the method is referred to as a “tire method”). In addition, there is also known a method using a magnetorheological polishing tool in which a magnetorheological fluid containing an abrasive material is supplied between a tool and a workpiece surface in a state in which the magnetorheological fluid is magnetically hardened and a workpiece is processed by moving the tool and the workpiece relative to each other. Further, there is also known a processing method using an ion beam.

Note that, in the following description, the processing is performed by fixing the tool and moving the workpiece, but the processing can be performed by moving at least one of the tool and the workpiece.

There are cases where anisotropy occurs in a unit removal shape, which is formed in a workpiece when a tool is stopped at a given position on the workpiece and the workpiece is processed for a unit time. For example, FIG. 4 illustrates the unit removal shape obtained by the tire method. Here, the unit removal shape has different cross-sectional shapes in an X-axis direction and a Y-axis direction. In a rotation surface on which the tool comes into contact with the workpiece, a contact pressure distribution in a rotation shaft direction (X-axis direction in FIG. 4) is different from a contact pressure distribution in a direction shaft perpendicular to the rotation direction (Y-axis direction in FIG. 4), and hence the anisotropy occurs in the unit removal shape, and a removal sensitivity has the anisotropy. In general, unlike a spherical tool whose contact surface coming into contact with the workpiece is circular to form an isotropic contact pressure distribution, the non-spherical tire-shaped tool has an anisotropic contact pressure distribution and an anisotropic unit removal shape. Note that, even in the spherical tool, the anisotropy can occur in the unit removal shape in a case where the spherical tool has the anisotropy in the application of a polishing liquid or in the rotation direction of the tool. Consequently, in many cases, there is a difference in the sensitivity of processing between when the tool is moved with the orientation of a rotation shaft of the tool matching a movement direction (scanning direction) of the tool and when the tool is moved with the orientation of the rotation shaft being orthogonal to the movement direction of the tool, and there is also a difference in a processing residual amount corresponding to a difference between a designed shape as a processing target and a shape after the processing.

Thus, Japanese Patent Application Laid-Open No. H09-267244 describes a method in which, when the workpiece surface is polished by a tool having anisotropy, the polishing is performed by repeating, multiple times, a procedure in which the workpiece is rotated by a given angle with respect to the scanning direction of the tool every time the workpiece surface is polished by the tool.

However, in the processing method described in Japanese Patent Application Laid-Open No. H09-267244, it is necessary to polish the workpiece surface multiple times, which leads to a problem in that a considerable processing time is necessary. In addition, in the processing method described in Japanese Patent Application Laid-Open No. H09-267244, when the workpiece is rotated by the given angle with respect to the scanning direction of the tool, there are cases where processing precision is reduced depending on the combination of the movement direction of the tool and the orientation of the workpiece with respect to the tool.

Accordingly, in order to reduce the processing time, it is conceivable to process the workpiece surface in one processing. However, in this case as well, there are cases where the processing precision is reduced depending on the combination of the movement direction of the tool and the orientation of the workpiece with respect to the tool.

### SUMMARY OF THE INVENTION

The present invention is aimed at providing a method of manufacturing a workpiece, which is capable of processing the workpiece in one processing with high precision by adjusting a relative movement direction of the workpiece with respect to a tool.

According to an exemplary embodiment of the present invention, there is provided a method of manufacturing a workpiece, for processing the workpiece by relatively scanning the workpiece and a tool having anisotropy in a unit removal amount, the method including: calculating, based on a target removal amount at each position of the workpiece and the unit removal amount as a processing amount of the tool for a unit time, a first dwell-time at the each position, and further calculating a first calculated removal amount based on the first dwell-time and the unit removal amount, to thereby determine a first difference as a difference between the first calculated removal amount and the target removal amount; and changing a relative orientation of the workpiece and the tool, calculating, in the changed relative orientation, a second dwell-time at the each position based on the target removal amount at the each position of the workpiece and the unit removal amount as the processing amount for the unit time, and further calculating a second calculated removal amount based on the second dwell-time and the unit removal amount, to thereby determine a second difference as a difference between the second calculated removal amount and the target removal amount, in which, when the second difference is smaller than the first difference, the workpiece is processed in a state in which the tool and the workpiece are positioned so as to have the changed relative orientation.

According to another exemplary embodiment of the present invention, there is provided a method of manufacturing a workpiece, for processing the workpiece by relatively scanning the workpiece and a tool having anisotropy in a unit removal amount, the method including: changing a relative orientation of the workpiece and the tool by multiple relative rotation angles, calculating, based on a target removal amount at each position of the workpiece and the unit removal amount as a processing amount of the tool for a unit time, a dwell-time at the each position for each of the multiple relative rotation angles, and further calculating a calculated removal amount based on the dwell-time and the unit removal amount, to thereby determine a difference between the calculated removal amount and the target removal amount; and comparing the differences respectively calculated for the multiple relative rotation angles with each other, to thereby determine a relative rotation angle having a smallest difference, in which the workpiece is processed in a state in which the tool and the workpiece are positioned so as to have an orientation of the determined relative rotation angle.

According to the method of manufacturing a workpiece of the present invention, the relative orientation of a unit removal shape and the workpiece is changed, relative positions of a rotation shaft of a rotating polishing tool and the workpiece are set so as to have the relative orientation having the smallest difference among differences between a calculated removal shape and a target removal shape determined for each of the relative orientations, and, in this state, the workpiece is processed. As a result, the method of manufacturing a workpiece of the present invention is capable of processing the workpiece with little error in one scanning, and hence it is possible to increase precision of the workpiece surface and improve processing efficiency by reducing the number of repetition of the processing.

Further features of the present invention will become apparent from the following description of exemplary embodiments with reference to the attached drawing.

### BRIEF DESCRIPTION OF THE DRAWINGS

FIG. 1 is a schematic front view of a processing apparatus used to implement a manufacturing method of the present invention.

FIGS. 2A and 2B are diagrams illustrating a relative movement of a tool and an XY stage, of which FIG. 2A is a partially enlarged view of the tool and the XY stage, and FIG. 2B is a plan view of FIG. 2A and is a schematic diagram illustrating a processing route of the tool on a surface of a workpiece.

FIG. 3 is a flowchart illustrating the manufacturing method of the present invention.

FIG. 4 illustrates a unit removal shape.

FIG. 5 is a plan view of a workpiece surface having a shell pattern before being subjected to processing of the workpiece in an embodiment of the present invention.

FIG. 6 illustrates a processing residual shape of the workpiece surface when the workpiece at a position of FIG. 5 is processed.

FIG. 7 illustrates the processing residual shape of the workpiece surface when the workpiece placed at a position obtained by rotating the position of FIG. 5 by 45 degrees with respect to the XY stage is processed.

FIG. 8 illustrates the processing residual shape of the workpiece surface when the workpiece placed at a position obtained by rotating the position of FIG. 5 by 90 degrees with respect to the XY stage is processed.

FIG. 9 is a plan view of the workpiece surface before being subjected to processing of the workpiece in Example of the present invention.

FIG. 10 is a graph showing a relationship between a relative rotation angle of a target removal shape with respect to a unit removal shape and a processing residual in Example of the present invention.

FIG. 11 illustrates the processing residual shape of the workpiece surface when the workpiece at a position of FIG. 9 is processed in Example of the present invention.

FIG. 12 illustrates the processing residual shape of the workpiece surface when the workpiece placed at a position obtained by rotating the position of FIG. 9 by 42 degrees with respect to the XY stage is processed.

### DESCRIPTION OF THE EMBODIMENTS

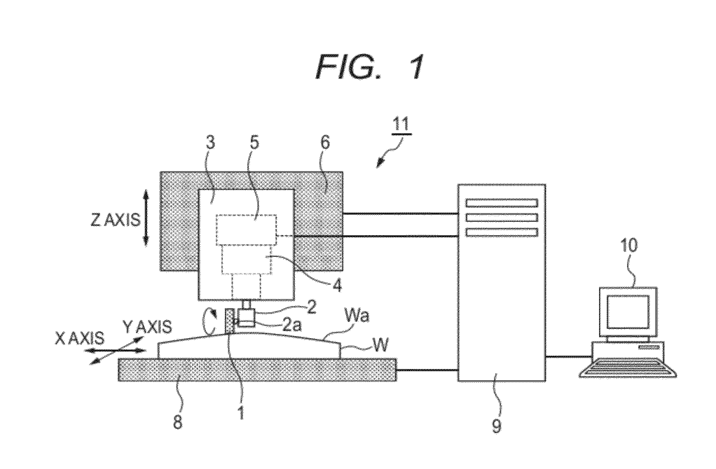

Hereinbelow, a method of manufacturing a workpiece in an embodiment of the present invention is described. Numerical values herein are reference values, and are not intended to limit the present invention. FIG. 1 is a schematic front view of a processing apparatus used to implement the method of manufacturing a workpiece of the present invention.

A tire-shaped tool 1 for processing a workpiece surface Wa of a workpiece W is attached to a rotation shaft 2a of a motor 2. The motor 2 rotates the tool 1 at a predetermined rotation speed. The motor 2 is provided in a load control apparatus 4. The load control apparatus 4 is provided in a tilt mechanism 5. The tilt mechanism 5 is provided in a polishing head 3. The polishing head 3 is provided in a Z stage 6. To an XY stage 8, the workpiece W is removably fixed.

In the structure described above, the load control apparatus 4 presses the tool 1 against the workpiece W at a predetermined load. The tilt mechanism 5 is capable of tilting the tool 1, the motor 2, and the load control apparatus 4 together in back-and-forth and right-and-left directions with respect to the polishing head 3 and the Z stage 6. The Z stage 6 is capable of moving the polishing head 3, the tilt mechanism 5, the load control apparatus 4, the motor 2, and the tool 1 together in a Z-axis direction (lifting and lowering). The XY stage 8 is capable of moving on a plane in an X-axis direction (right-and-left direction) and a Y-axis direction (back-and-forth direction). The motor 2, the Z stage 6, the XY stage 8, and the tilt mechanism 5 are operated by the control of a control apparatus 9. The control apparatus 9 performs a control operation based on an operation signal of a terminal PC 10.

The tool 1 moves between (scans) positions on the workpiece W while being tilted in accordance with a curvature of a processing shape of the workpiece W through the operation of each of the Z stage 6, the XY stage 8, and the tilt mechanism 5 by the control of the control apparatus 9. A relative scanning pattern of the tool 1 with respect to the workpiece W and movement speed data of the tool 1 at each position of the workpiece are input to the control apparatus 9 from the terminal PC 10. At this point, the tool 1 is perpendicularly pressed against the workpiece surface at a predetermined load while being rotated at a controlled predetermined rotation speed by the motor 2 and the load control apparatus 4, and moves while processing the workpiece W.

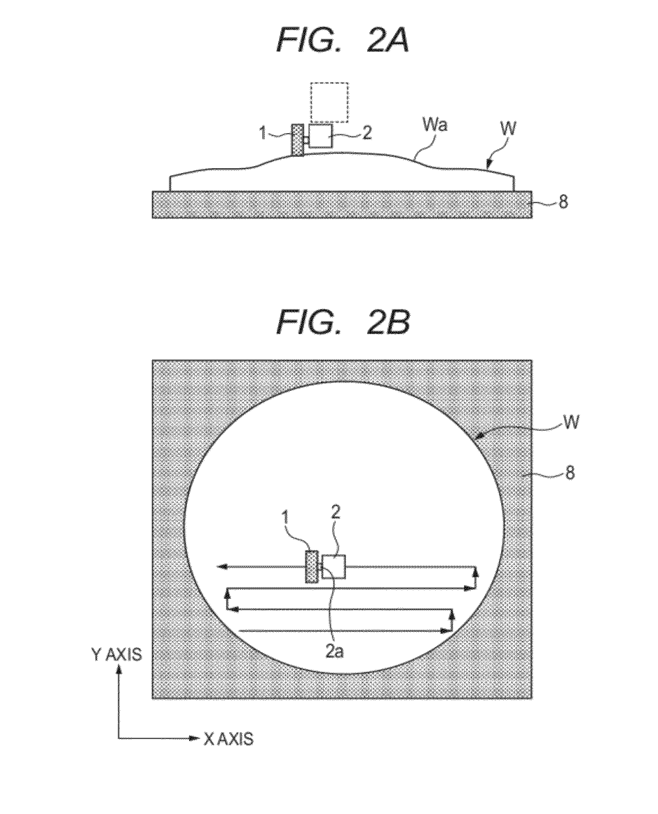

FIG. 2A is a partially enlarged view of the tool 1 and the XY stage 8. FIG. 2B is a plan view of FIG. 2A, and is a schematic diagram illustrating a polishing route of the tool on the surface of the workpiece.

When the workpiece W is moved in the X-axis direction and the Y-axis direction on the XY stage 8, the tool 1 generates a scanning pattern as illustrated in FIG. 2B on the workpiece W to process the workpiece surface Wa.

The processing in this embodiment is performed by fixing the tool 1 and moving the workpiece W. However, it is only necessary to perform processing by moving at least one of the tool and the workpiece, and the processing is not limited to that in this embodiment.

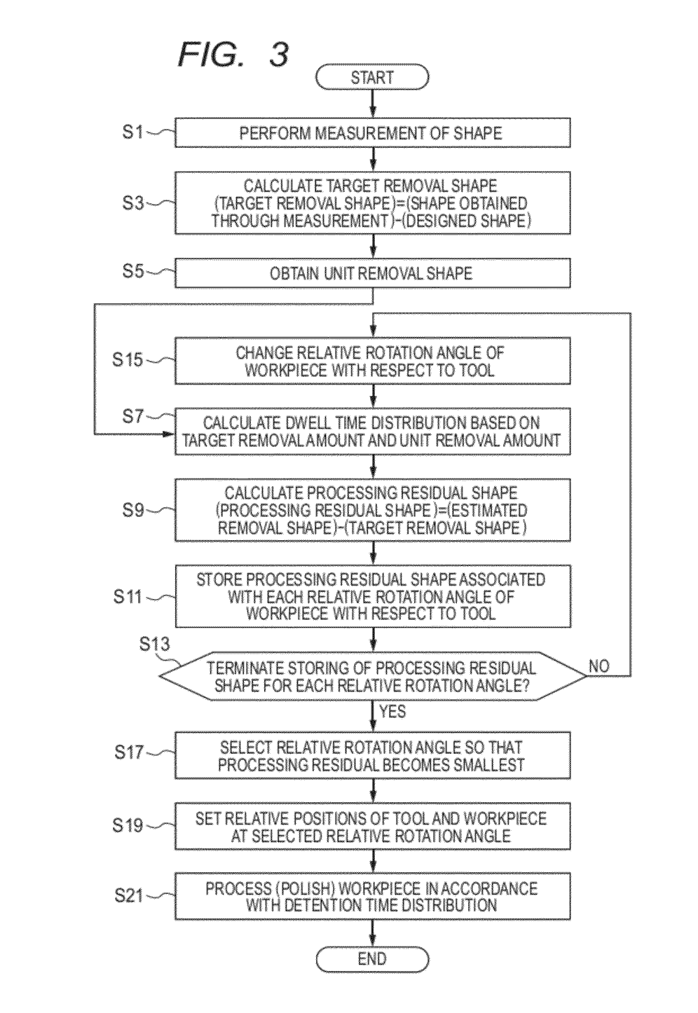

Next, based on a flowchart of FIG. 3, the method of manufacturing the workpiece W is described.

First, a target removal amount at each position of the workpiece is determined. Specifically, the target removal amount can be determined by, for example, the following method. The terminal PC 10 performs the measurement of the shape of the workpiece surface Wa using a shape measurement apparatus (not shown) (S1), and calculates a target removal shape, which is as a difference between the shape obtained through the measurement and a pre-stored designed shape (S3). Accordingly, the target removal amount is determined. That is, the terminal PC 10 calculates a processing amount. The workpiece W is fixed to the XY stage when the shape of the workpiece surface Wa is measured, and the workpiece W is fixed at the same position and the same direction as that at which the workpiece W is fixed when the workpiece W is processed. That is, the workpiece surface of the workpiece is positioned at a position determined in the rotation direction in an XY plane (in-plane rotation direction).

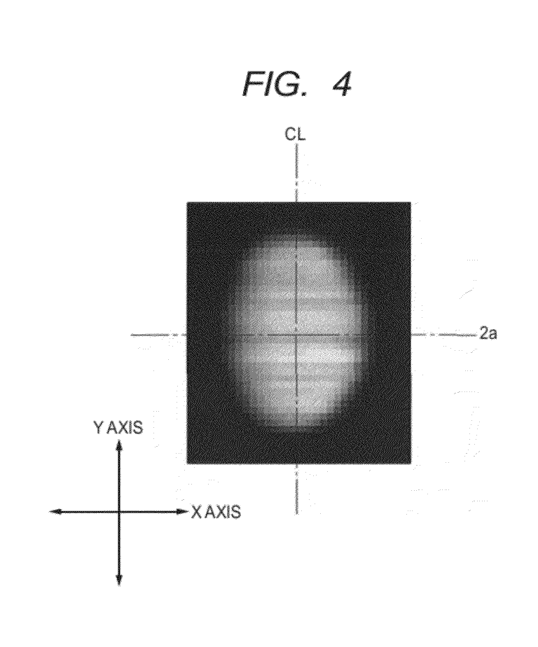

Next, the terminal PC 10 obtains a unit removal shape as a unit removal amount, which is a processing amount of the tool per unit time (S5). The unit removal shape is obtained by processing a smooth test work (test workpiece) having the same material as those of the workpiece by using a tool that is used when the workpiece is actually polished. The unit removal shape is a shape of a portion removed by the processing when the test work or the workpiece is processed without moving the tool and the work relative to each other for a given time (unit time). The shape of portion removed by the processing is calculated by a shape measuring apparatus (not shown) to obtain the unit removal shape. At this point, the orientation of the test work with respect to the rotation shaft of a test tool is the same as that of the workpiece with respect to the rotation shaft of the tool that actually processes the workpiece. In addition, it is assumed that the tool polishes a given portion of the test work without moving for the unit time while a given load is applied to the tool by the load control apparatus 4. FIG. 4 illustrates an example of the unit removal shape, and the unit removal shape is formed so as to depress the test work. Note that, Step S5 may be performed before Step S1.

Subsequently, based on the target removal amount at each position of the workpiece and the unit removal amount, which is the processing amount of the tool for the unit time, a first dwell-time at each position is calculated. Specifically, the terminal PC 10 calculates a dwell-time distribution (first dwell-time at each position of the workpiece) based on the target removal shape (target removal amount at each position of the workpiece) and the unit removal shape (unit removal amount) (S7). The dwell-time distribution indicates a distribution state of a movement speed of the workpiece W at each position with respect to the tool. The dwell-time distribution is calculated by dividing the target removal shape by the processing amount per unit time of test processing. Note that, as a method of calculating the dwell-time, for example, the following methods are known. For example, in a method proposed in Japanese Patent Application Laid-Open No. H10-337638, the approximate function of the dwell-time distribution is optimized such that the total sum of the square of a difference between the target removal shape and a calculated removal shape that is expected to be removed when the processing is performed based on the dwell-time is reduced. In addition, a method using Fourier transformation is also proposed (see Journal Precision Engineering, 62, (1996), 408). In a portion having a large target removal shape as the processing amount of the workpiece, a time during which the tool stays (dwell-time) is long.

Then, a first calculated removal amount is calculated based on the first dwell-time and the unit removal amount, and a first difference, which is a difference between the first calculated removal amount and the target removal amount, is calculated. Specifically, the terminal PC 10 calculates a processing residual shape (first difference) (S9). In general, the unit removal shape having a given three-dimensional shape is used, and hence, even when the processing is performed in conformity with the dwell-time distribution, the processing exactly conforming to the target removal shape cannot necessarily be performed. Note that, if the unit removal shape is an infinitesimal point, the processing exactly conforming to the target removal shape is possible. Consequently, the difference between the calculated removal shape obtained by calculation that is expected to be removed when the workpiece is processed while controlling the movement speed of the workpiece with respect to the tool based on the dwell-time distribution (first calculated removal amount at each position of the workpiece) and the target removal shape (target removal amount at each position of the workpiece) is calculated as the processing residual shape (first difference at each position of the workpiece) (S9). Note that, the calculated removal shape can be calculated by multiplying the dwell-time at each position of the workpiece W by the unit removal shape (unit removal amount) (see, for example, Japanese Patent Application Laid-Open No. H10-337638).

Next, a relative orientation of the workpiece and the tool is changed. In the changed relative orientation, based on the target removal amount at each position of the workpiece and the unit removal amount, which is the processing amount for the unit time, a second dwell-time at each position is calculated, a second calculated removal amount is further calculated based on the second dwell-time and the unit removal amount, and a second difference, which is as a difference between the second calculated removal amount and the target removal amount, is calculated. Specifically, the tool is a tire-shaped tool, and has anisotropy occurring in the unit removal shape illustrated in FIG. 4 because contact pressure distribution of the tool has anisotropy with regard to the workpiece surface Wa. The unit removal shape has anisotropy so that the distribution of the processing residual differs depending on the orientation of the tool with respect to the workpiece surface Wa. That is, the distribution of the processing residual differs between when the orientation of the rotation shaft 2a serving as the rotation shaft of each of the motor 2 and the tool 1 matches the movement direction of the workpiece as illustrated in FIG. 2B, and when the orientation of the rotation shaft 2a is orthogonal to the movement direction of the workpiece (not shown).

Consequently, the terminal PC 10 calculates the processing residual shape when the workpiece surface is rotated in a range of 0 degrees to 90 degrees with respect to the rotation shaft 2a of the tool 1. That is, the terminal PC 10 calculates the processing residual shapes at angles ranging from 0 degrees, at which the orientation of the rotation shaft 2a of the motor 2 matches the movement direction of the workpiece, to 90 degrees, at which the orientation of the rotation shaft 2a is orthogonal to the movement direction of the workpiece (S9) (second difference). When the second difference is smaller than the first difference, the workpiece is processed in a state in which the tool and the workpiece are positioned so as to have the changed relative orientation.

In this case, as illustrated in FIG. 4, in the unit removal shape, which is the shape of the unit time removal amount and is symmetric with respect to a unit line CL, it is sufficient to calculate the processing residual shape at the relative rotation angle as the relative orientation from 0 degrees to 90 degrees. However, in a shape that is not symmetric with respect to a line, it is necessary to calculate the processing residual shape from 0 degrees to 180 degrees.

A method of calculating the processing residual shape is described. The tool of this embodiment is a tool that forms the unit removal shape as illustrated in FIG. 4, and hence it is assumed that a processing residual shape obtained when the workpiece is rotated at least once in the range of the rotation angle of 0 degrees to 90 degrees or, in this embodiment, every time the workpiece is rotated by degrees (angle is not limited to 15 degrees) is determined.

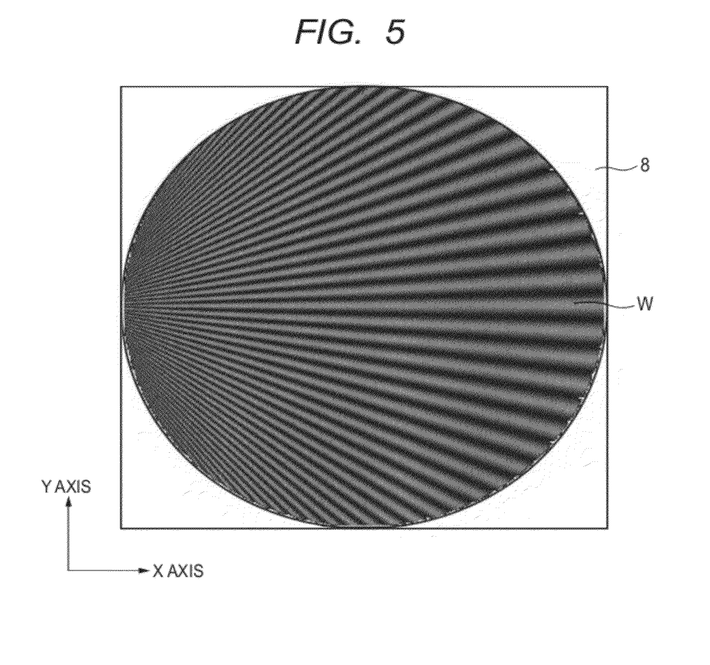

The workpiece surface Wa of the workpiece is assumed to have a shell pattern as illustrated in FIG. 5. The tool is assumed to perform the processing of removing black straight portions of the shell pattern. In addition, the target removal shape of the shell pattern is assumed to have the roughness of 35.35 nm in root mean square (RMS) in an effective surface.

The unit removal shape of the tool has a shape elongated in the Y-axis direction, as illustrated in FIG. 4. The cross-sectional shape of the unit removal shape changes in the X-axis direction more sharply than in the Y-axis direction. When each cross-sectional shape is subjected to frequency resolution and is replaced with a relationship between a wavelength and a spectrum intensity, the X-axis direction has frequency components higher than those of the Y-axis direction. This indicates that the tool can remove the shape having the high frequency component more in the X-axis direction than in the Y-axis direction, and removal precision differs depending on the orientation.

The target removal shape illustrated in FIG. 5 has ripples substantially in the Y-axis direction. As a result, it is difficult to perform the removal of the workpiece W having the orientation illustrated in FIG. 5 by using the unit removal shape having the orientation illustrated in FIG. 4.

Accordingly, the workpiece W having the target removal shape of FIG. 5 is rotated with respect to the tool, and the placement position of the workpiece W on the XY stage 8 is changed. When the workpiece W is rotated so that the direction of the ripples of the target removal shape becomes closer to the X-axis direction, the removal of the ripples (roughness) is facilitated, and the processing residual is reduced.

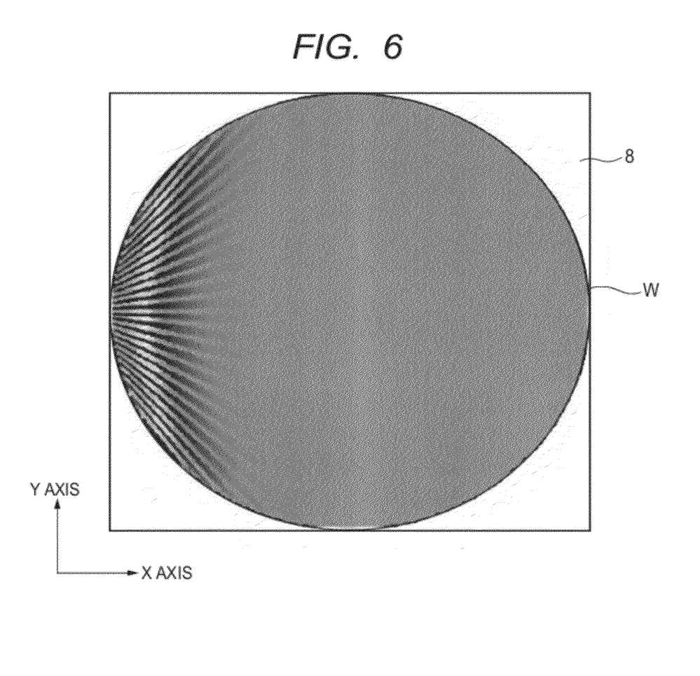

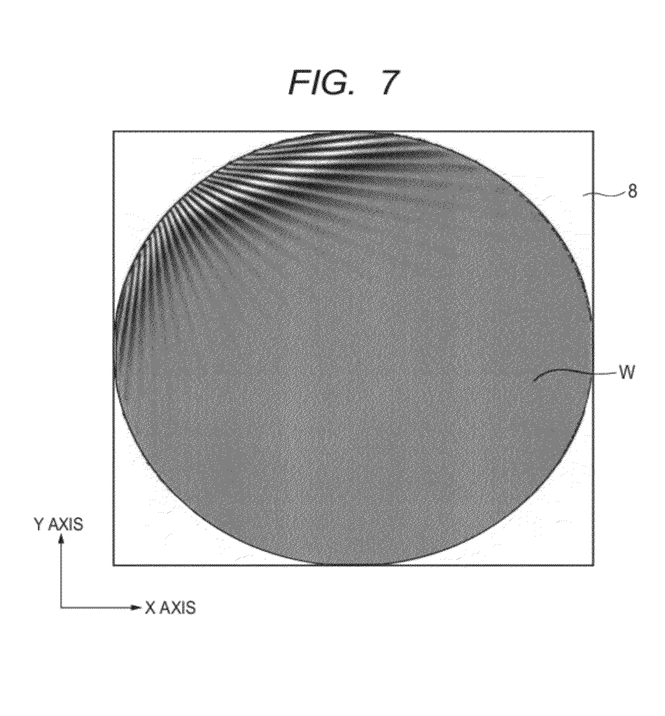

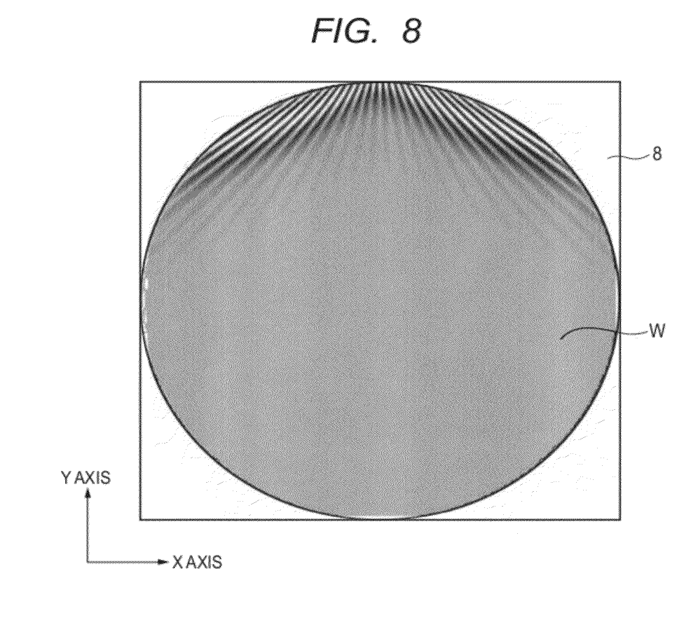

FIG. 6 illustrates the result of calculation of the processing residual shape (difference) of the target removal shape of FIG. 5. (The target removal shape is not rotated.) FIGS. 7 and 8 illustrate the results of calculation of the processing residual shapes (respective differences for the relative rotation angles) when the target removal shape of FIG. 5 is rotated by 45 degrees and 90 degrees, respectively. In each of the left portion of the workpiece surface of FIG. 7 and the upper central portion of the workpiece surface of FIG. 8, the direction of the ripples before the processing corresponds to the X-axis direction so that the residual after the processing is smaller than that of the corresponding portion of FIG. 6. That is, the amount of removed ripples is increased.

Subsequently, the respective differences for the relative rotation angles are compared with each other. As can be seen from the comparison between FIGS. 6 and 8, the residual is smaller in the case of FIG. 8 in which the workpiece W having the shell pattern of the target removal shape is rotated by 90 degrees with respect to the X axis than in the case of FIG. 6. The calculated processing residual in the surface is 8.56 nm in RMS when the relative rotation angle is 0 degrees (FIG. 6), and is 7.14 nm when the relative rotation angle is 90 degrees (FIG. 8). Thus, when the orientation (relative rotation angle) of the workpiece with respect to the tool is changed to substantially match the direction in which the roughness of the target removal shape of the workpiece surface is significantly present with the direction in which the processing sensitivity of the tool is high, it is possible to efficiently remove the roughness.

Thus, the terminal PC 10 calculates and stores the processing residual shape (difference) for each relative rotation angle (S9, S11, S15, S7, S9, S11, and S13), and selects, as a processing condition, the relative rotation angle having the smallest processing residual (difference) (S17). The workpiece is rotated by the selected relative rotation angle and is placed on the XY stage 8 (S19). Note that, instead of rotating the workpiece W, the polishing head 3 may be rotated with respect to the workpiece. In this case, it is necessary to provide, in the processing apparatus, a θ-axis stage (not shown) for rotationally positioning the polishing head 3 in a horizontal direction. In the example of the shell pattern described above, the workpiece is rotated by 90 degrees and is placed on the θ-axis stage.

After the workpiece is placed at the predetermined position of the XY stage, a processing apparatus 11 processes (polishes) the workpiece in accordance with the tool relative scanning pattern and dwell-time distribution data at the selected relative rotation angle (S21).

As has been described above, in the method of manufacturing the workpiece of this embodiment, the workpiece W and the tool 1 as a rotating tool having anisotropy in the unit removal shape are abutted against each other, and the workpiece is processed by moving the workpiece W and the tool 1 relative to each other.

In the manufacturing method of this embodiment, the relative orientation of the workpiece and the tool is calculated based on mainly the following first and second steps. The first step is a step of calculating the first dwell-time at each position based on the target removal amount at each position of the workpiece and the unit removal amount, which is the processing amount of the tool for the unit time, and further calculating the first calculated removal amount based on the first dwell-time and the unit removal amount, to thereby determine the first difference, which is the difference between the first calculated removal amount and the target removal amount. The second step is a step of changing the relative orientation of the workpiece and the tool, calculating, in the changed relative orientation, the second dwell-time at each position based on the target removal amount at each position of the workpiece and the unit removal amount, which is as the processing amount for the unit time, and further calculating the second calculated removal amount based on the second dwell-time and the unit removal amount, to thereby determine the second difference, which is the difference between the second calculated removal amount and the target removal amount.

Further, when the second difference is smaller than the first difference, the workpiece is processed in the state in which the tool and the workpiece are positioned so as to have the changed relative orientation.

Alternatively, the manufacturing method of this embodiment includes a step of changing the relative orientation of the workpiece and the tool by multiple relative rotation angles, calculating the dwell-time at each position based on the target removal amount at each position of the workpiece and the unit removal amount, which is the processing amount of the tool for the unit time for each of the multiple relative rotation angles, and further calculating the calculated removal amount based on the dwell-time and the unit removal amount, to thereby determine the difference between the calculated removal amount and the target removal amount. Further, the differences respectively calculated for the multiple relative rotation angles are compared with one another, and the relative rotation angle having the smallest difference is thereby determined, and the workpiece is processed in the state in which the tool and the workpiece are positioned so as to have the orientation of the determined relative rotation angle.

Thus, in this manufacturing method, the relative orientation of the tool and the workpiece having the smallest difference between the calculated removal shape and the target removal shape is selected, and the workpiece is processed in accordance with the dwell-time distribution. As a result, in this polishing method, the workpiece is processed while the relative movement speed is adjusted in accordance with the dwell-time distribution so that the designed shape is attained, and hence it is possible to process the workpiece in one processing with high precision. In addition, it is possible to suitably use the method of manufacturing the workpiece of the present invention in the processing of the workpiece typified by an optical element such as a lens or a mirror, a metal such as a die, and a semiconductor substrate such as a silicon wafer.

### EXAMPLE

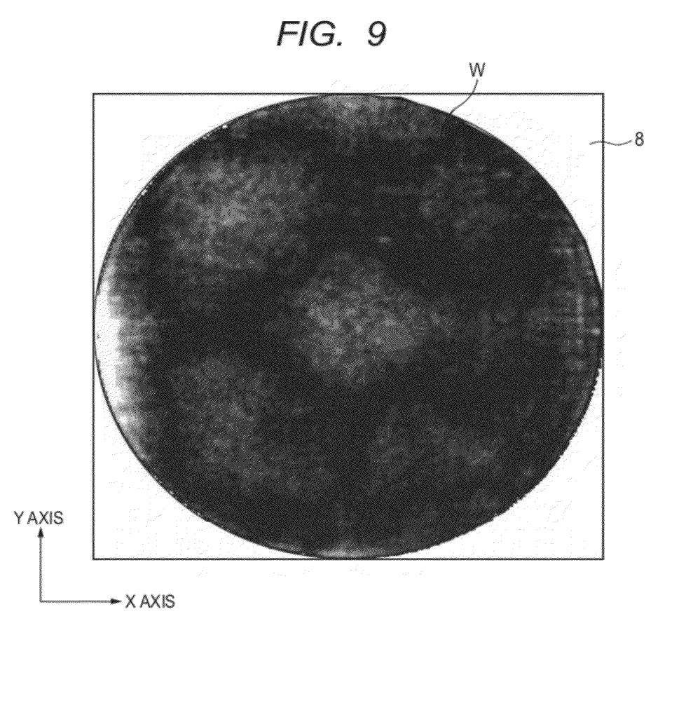

FIG. 9 is a plan view of a workpiece formed with a target removal pattern according to Example of the present invention. The workpiece has a circular shape having an effective diameter of 170 mm, and has the roughness of 3.54 nm in root mean square (RMS) in an effective surface. The material of the workpiece is synthetic quartz glass. The workpiece surface is non-spherical. The shape of the workpiece surface was measured by a probe-type shape measurement apparatus before processing. Based on a difference between the shape obtained through the measurement and a designed shape, a target removal shape was calculated.

The diameter of a tool in Example is φ20 mm, and the rotation speed of the tool during the processing is constantly 20 Hz. The tool is, for example, a tire-shaped tool made of SUS, and urethane foam is provided on the outer peripheral surface that comes into contact with the workpiece. The hardness of the urethane foam is, for example, A80 degrees. The tool is pressed against the workpiece surface so that the rotation shaft 2a of the tool is perpendicular to a normal of the workpiece surface.

The tool is perpendicularly pressed against the workpiece surface at a constant load of 150 gf by the load control apparatus 4. A polishing liquid is discharged from an outlet port to be supplied to a processing position, sucked into an inlet port opposing the outlet port to be collected and filtered, and discharged from the outlet port again. In this manner, the polishing liquid is circulated to be used. The polishing liquid contains a cerium oxide abrasive grain, and its concentration is, for example, 0.5%. The workpiece is processed by the tool while repeating the scanning movement in the X-axis direction and the feed movement in the Y-axis direction. The average scanning speed during this processing is 1.0 mm/s. A tool feed movement amount in the Y-axis direction is 0.3 mm in each scanning.

FIG. 4 illustrates a unit removal shape used in Example. The unit removal shape is formed into a synthetic quartz plate by causing the tool to process the synthetic quartz plate as a test work at a given position for one minute without scanning the tool before the main processing. In addition, the tool used in this processing is the same as the tool to be actually used. Further, the processing conditions are the same as those of the actual processing except that the processing is performed at the given position without scanning the tool. The unit removal shape was three-dimensionally measured by using an interference microscope. The unit removal shape is symmetric with respect to the rotation shaft 2a of the tool (also serving as the rotation shaft of the motor 2) so that the central axis of the unit removal shape matches the rotation shaft of the tool. The rotation direction position of the removal shape is adjusted so that both of the central axis and the rotation shaft match the X axis.

The terminal PC 10 calculates a dwell-time distribution for the target removal shape of FIG. 9 based on the unit removal shape of FIG. 4. In addition, the terminal PC 10 calculates a processing residual shape as a difference between a calculated removal shape, which is estimated when the processing is performed in accordance with the dwell-time distribution, and the target removal shape. The processing residual shape was 1.136 nm in root means square (RMS) in the effective surface. Further, the same calculation was performed on the shapes obtained by clockwise rotating the target removal shape of FIG. 9 multiple times by 15 degrees each, without changing the unit removal shape of FIG. 4. That is, the relative orientation of the tool and the workpiece was changed multiple times by 15 degrees each, and the RMS in the effective surface was calculated for each relative orientation. As the result of the calculation, the root mean square (RMS) in the effective surface when the relative orientation was rotated by 45 degrees was the smallest at 1.054 nm.

Consequently, based on the estimation that the average processing residual in the surface was minimized in the vicinity of the relative rotation angle of 45 degrees, the relative rotation angle was set to 40 degrees and 42 degrees to calculate the processing residual shape by the terminal PC 10. As the result, when the relative rotation angle was 42 degrees, the RMS of 1.050 nm was obtained as the smallest value of the processing residual in the surface.

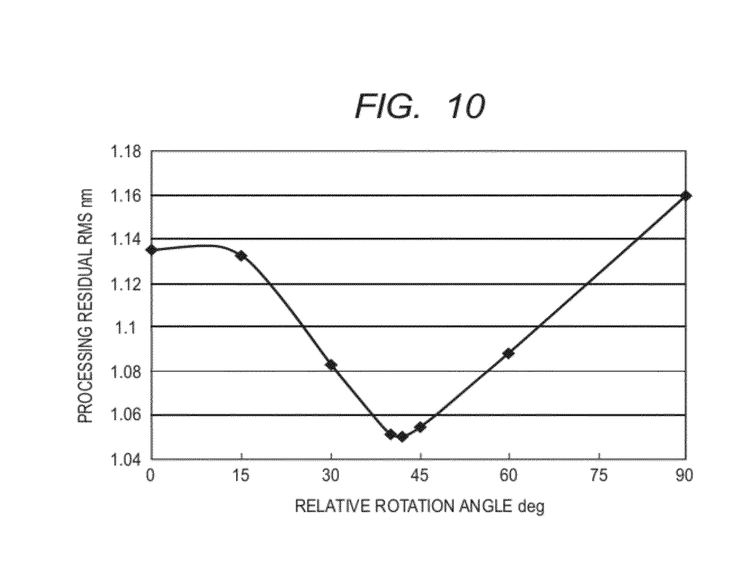

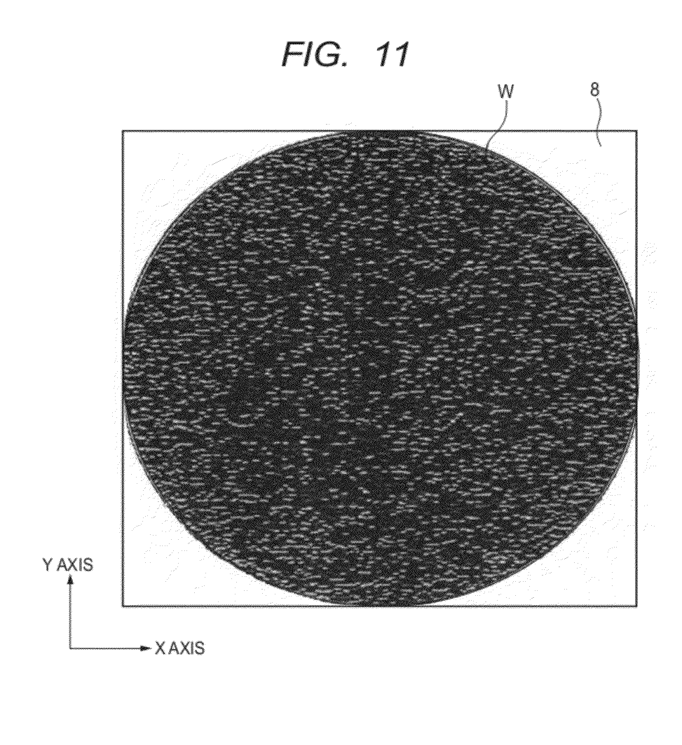

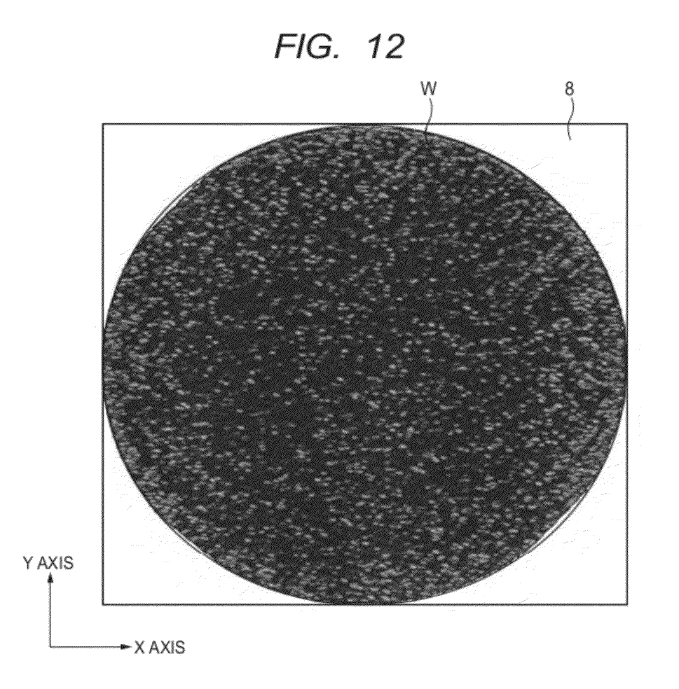

FIG. 10 shows the result of the calculation described above. In Example, as shown in FIG. 10, the calculation was terminated at the relative rotation angle of 42 degrees that appeared to be the minimum value in the graph, but the search for an angle having a smaller residual may be continued. FIG. 11 illustrates the processing residual shape at the relative rotation angle (relative orientation) of 0 degrees calculated without relatively rotating the target removal shape with respect to the unit removal shape of FIG. 4. FIG. 12 illustrates the processing residual shape calculated by relatively rotating the target removal shape with respect to the unit removal shape by 42 degrees clockwise. In the processing residual shape of FIG. 11, ripple components in the Y-axis direction are observed. In the processing residual shape of FIG. 12, the residual of the ripple components in the Y-axis direction is small as compared with that in FIG. 11. As the result, as described above, the root mean square (RMS) value in the effective surface in FIG. 12 is smaller than that in FIG. 11.

In Example, the workpiece was actually processed at the position obtained by rotating the workpiece by 42 degrees. That is, the workpiece W was fixed to the XY stage 8 at the position at which the workpiece W was rotated by 42 degrees from the position at which the orientation of the workpiece relative to the tool was 0 degrees. The XY stage 8 was scanned with respect to the tool in accordance with the dwell-time distribution obtained through the calculation for the relative rotation angle of 42 degrees, and the workpiece surface was processed in one processing. When the processed surface was measured by the probe-type shape measurement apparatus again and the processing residual was calculated, the RMS was 1.052 nm. As compared with the RMS of 1.136 nm as the processing residual estimated when the processing was performed in the state in which the relative rotation angle was 0 degrees without changing the relative rotation angle of the workpiece with respect to the tool, the workpiece surface having high precision was able to be obtained.

The tire-shaped tool was used in Example, but the present invention is not limited thereto. A similar effect can be obtained in a processing method having anisotropy in the unit removal shape such as processing using a magnetorheological polishing tool or processing by an ion beam from an ion beam irradiation apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-115388, filed May 24, 2011, which is hereby incorporated by reference herein in its entirety.

What is claimed is:

1. A method of manufacturing a workpiece, for processing the workpiece by relatively scanning the workpiece and a tool having anisotropy in a unit removal amount,
the method comprising:
calculating, based on a target removal amount at each position of the workpiece and the unit removal amount as a processing amount of the tool for a unit time, a first dwell-time at the each position, and further calculating a first calculated removal amount based on the first dwell-time and the unit removal amount, to thereby determine a first difference as a difference between the first calculated removal amount and the target removal amount; and
changing a relative orientation of the workpiece and the tool, calculating, in the changed relative orientation, a second dwell-time at the each position based on the target removal amount at the each position of the workpiece and the unit removal amount as the processing amount for the unit time, and further calculating a second calculated removal amount based on the second dwell-time and the unit removal amount, to thereby determine a second difference as a difference between the second calculated removal amount and the target removal amount,
wherein, when the second difference is smaller than the first difference, the workpiece is processed in a state in which the tool and the workpiece are positioned so as to have the changed relative orientation.

2. A method of manufacturing a workpiece, for processing the workpiece by relatively scanning the workpiece and a tool having anisotropy in a unit removal amount,
the method comprising:
changing a relative orientation of the workpiece and the tool by multiple relative rotation angles, calculating, based on a target removal amount at each position of the workpiece and the unit removal amount as a processing amount of the tool for a unit time, a dwell-time at the each position for each of the multiple relative rotation angles, and further calculating a calculated removal amount based on the dwell-time and the unit removal amount, to thereby determine a difference between the calculated removal amount and the target removal amount; and
comparing the differences respectively calculated for the multiple relative rotation angles with each other, to thereby determine a relative rotation angle having a smallest difference,
wherein the workpiece is processed in a state in which the tool and the workpiece are positioned so as to have an orientation of the determined relative rotation angle.

3. The method of manufacturing a workpiece according to claim 1, wherein the tool comprises a tire-shaped rotating tool.

4. The method of manufacturing a workpiece according to claim 1, wherein the tool comprises a magnetorheological polishing tool.

5. The method of manufacturing a workpiece according to claim 1, wherein the tool comprises an ion beam irradiation apparatus.

6. The method of manufacturing a workpiece according to claim 1, wherein the workpiece comprises an optical element.

7. The method of manufacturing a workpiece according to claim 1, wherein the workpiece comprises a die.

8. The method of manufacturing a workpiece according to claim 1, wherein the workpiece comprises a semiconductor substrate.
